(19) United States
(12) Patent Application Publication
(10) Pub. No.: US 2009/0111998 A1
(43) Pub. Date: Apr. 30, 2009

(54) PROCESS FOR THE PREPARATION OF CARVEDILOL DIHYDROGEN PHOSPHATE HEMIHYDRATE AND PHARMACEUTICAL COMPOSITIONS THEREOF

(76) Inventors: Srinivas Reddy Gade, Hyderabad (IN); Srinivas Reddy Mallepalli, Hyderabad (IN)

Correspondence Address: DR. REDDY''S LABORATORIES, INC., 200 SOMERSET CORPORATE BLVD, SEVENTH FLOOR, BRIDGEWATER, NJ, 08807-2862, US

(21) Appl. No.: 12/257,775

(22) Filed: Oct. 24, 2008

Related U.S. Application Data
(60) Provisional application No. 61/056,934, filed on May 29, 2008.

(30) Foreign Application Priority Data
Oct. 25, 2007 (IN) 2419/CHE/2007

(51) Int. Cl. C07F 9/02

(52) U.S. Cl. 548/414

(57) ABSTRACT

There is provided processes for preparing carvedilol dihydrogen phosphate hemihydrate, which processes include at least one of the steps of: (a) providing a solution of carvedilol in a mixture of organic solvent (s) and/or water; (b) adding a phosphonating agent to the reaction mixture of step (a); and (c) further processing to obtain carvedilol dihydrogen phosphate hemihydrate. There is also provided pharmaceutical compositions comprising carvedilol dihydrogen phosphate hemihydrate and processes for their preparation.

### INTRODUCTION

The present application relates to carvedilol dihydrogen phosphate hemihydrate, processes for preparing carvedilol dihydrogen phosphate hemihydrate, and pharmaceutical compositions of carvedilol dihydrogen phosphate hemihydrate.

Carvedilol phosphate is the adopted name of (±)-1-(9H-carbazol-4-yloxy)-3[2-(2-methoxyphenoxy] ethyl aminopropan-2-ol phosphate with the following structure.

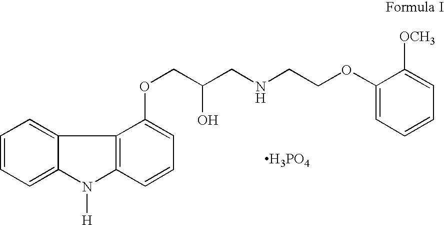

Carvedilol is a nonselective β-adrenergic blocking agent with α1-blocking activity. It is indicated in the treatment of mild to moderate congestive heart failure. Carvedilol phosphate is marketed under the trade name COREG CR®.

Carvedilol was disclosed in U.S. Pat. No. 4,503,067. The patent also describes processes for the preparation of carvedilol.

U.S. Patent Application Publication No. 2005/240027 discloses various crystalline forms of carvedilol phosphate and their use in the preparation of pharmaceutical compositions.

Indian Patent Application Publication No. 929/MUM/2007A describes processes for the preparation of crystalline carvedilol phosphate using solvents such as acetonitrile, acetone and THF. It also discloses methanol, ethanol and isopropanol solvates of carvedilol phosphate.

International Publication No. 2008/002683 discloses various crystalline and amorphous forms of carvedilol phosphate, processes for preparing those forms, and the use of those forms in the preparation of pharmaceutical compositions.

### SUMMARY

The present application relates to carvedilol dihydrogen phosphate hemihydrate, processes for preparing carvedilol dihydrogen phosphate hemihydrate, and pharmaceutical compositions of carvedilol dihydrogen phosphate hemihydrate.

There is provided processes for preparing carvedilol dihydrogen phosphate hemihydrate, which processes include at least one of the steps of:
(a) providing a solution of carvedilol in a mixture of organic solvent(s) and/or water;
(b) adding a phosphonating agent to the reaction mixture of step (a); and
(c) further processing to obtain carvedilol dihydrogen phosphate hemihydrate.

There is also provided pharmaceutical compositions comprising carvedilol dihydrogen phosphate hemihydrate and processes for their preparation.

### DETAILED DESCRIPTION OF THE APPLICATION

The present application relates to carvedilol dihydrogen phosphate hemihydrate, processes for preparing carvedilol dihydrogen phosphate hemihydrate, and pharmaceutical compositions of carvedilol dihydrogen phosphate hemihydrate.

There is provided processes for preparing carvedilol dihydrogen phosphate hemihydrate, which processes include at least one of the steps of:
(a) providing a solution of carvedilol in a mixture of organic solvent(s) and/or water;
(b) adding a phosphonating agent to the reaction mixture of step (a); and
(c) further processing to obtain carvedilol dihydrogen phosphate hemihydrate.

The carvedilol may be dissolved in water, organic solvent, or a mixture of water and organic solvent. The organic solvent may be a single solvent or a mixture of solvents. The ratio of water and organic solvent may be about 0.5:50 to about 1:10.

The solution of carvedilol may be obtained directly from the reaction mixture of a previous step. The starting carvedilol may also be provided as a solid, in the form of carvedilol base or its pharmaceutically acceptable salts.

Non-limiting examples of suitable organic solvents that can be used to form the starting solution include halogenated hydrocarbons, such as dichloromethane, 1,2-dichloroethane, chloroform, and carbon tetrachloride; esters, such as ethyl acetate, n-propyl acetate, n-butyl acetate, and t-butyl acetate; ethers, such as diethyl ether, dimethyl ether, diisopropyl ether, methyl tert. butyl ether, 1,4-dioxane, and tetrahydrofuran; hydrocarbons, such as toluene, xylene, n-heptane, cyclohexane, n-hexane, and the like; nitriles, such as acetonitrile and propionitrile; dimethylformamide; N,N-dimethylacetamide; dimethylsulfoxide; N-methyl pyrrolidone; or mixtures thereof. The solution of carvedilol may be prepared in water without using any other solvent.

The amount of solvent or mixture of solvents used for dissolution depends on the solvent and the dissolution temperature adopted. The concentration of carvedilol in the solution may generally range from about 0.1 g/ml to about 10 g/ml.

The solution of carvedilol obtained above may be heated for better dissolution and to get a clear solution. The undissolved particles can be removed suitably by filtration, centrifugation, decantation, and other techniques, such as solution passing through paper, glass fiber, or other membrane material. Depending upon the equipment used, the concentration of carvedilol desired, and the temperature of the solution, the filtration apparatus may need to be preheated to avoid premature crystallization.

Suitable phosphonating agents that may be used include, and are not limited to, phosphoric acid, dialkyl phosphates, such as, for example, dimethyl phosphite, diethyl phosphite, dipotassium hydrogen phosphate, ammonium dihydrogen ortho phosphate, and sodium dihydrogen ortho phosphate. A mixture of phosphonating agents may be used if desired. The phosphonating agent may be added to the carvedilol solution at room temperature or the addition can be carried out at elevated temperatures such as about 35° C. to about 100° C. and the addition may take from about 30 minutes to about 5 hours. The obtained reaction mixture may be further stirred.

In one variant, the solvent may be removed using any of the suitable methods such as evaporation, atmospheric distillation, or distillation under vacuum.

Distillation of the solvent may be conducted under a vacuum, such as below about 100 mm Hg to below about 600 mm Hg, at elevated temperatures, such as about 20° C. to about 70° C. Any temperature and vacuum conditions can be used as long as there is no increase in the impurity levels of the product.

Suitable techniques that may be used for the distillation include distillation using a rotational evaporating device, such as a rotary evaporator, spray drying, agitated thin film drying (“ATFD”), lyophilization, and the like.

The solid material may be collected from the final mixture, with or without cooling below the operating temperature, by any techniques, such as, for example, filtration by gravity or suction, centrifugation, and the like. The solid so isolated will carry a small proportion of occluded mother liquor containing a higher percentage of impurities. If desired the solid can be washed with a solvent to remove the mother liquor.

The solid material obtained by any of the techniques described above may be optionally further dried. Drying may be suitably carried out by any known mechanism, non-limiting examples of which include a tray dryer, vacuum oven, air oven, or using a fluidized bed drier, spin flash dryer, flash dryer and the like. The drying may be carried out at reduced pressures and at temperatures such as about 35° C. to about 70° C. for a time period that achieves the desired result.

The present invention includes pharmaceutical compositions comprising carvedilol dihydrogen phosphate hemihydrate and at least one pharmaceutically acceptable carrier.

Carvedilol dihydrogen phosphate hemihydrate can be formulated as solid compositions for oral administration in the form of capsules, tablets, pills, powders, or granules. In these compositions, the active product is mixed with one or more pharmaceutically acceptable excipients. The drug substance can be formulated as liquid compositions for oral administration, including, for example, solutions, suspensions, syrups, elixirs, and emulsions, that contain solvents or vehicles, such as, for example, water, sorbitol, glycerine, propylene glycol, or liquid paraffin.

Compositions comprising carvedilol dihydrogen phosphate hemihydrate for parenteral administration can be suspensions, emulsions, or aqueous or non-aqueous sterile solutions. As a solvent or vehicle, propylene glycol, polyethylene glycol, vegetable oils, especially olive oil, and injectable organic esters, e.g., ethyl oleate, may be employed. These compositions can contain adjuvants, especially wetting, emulsifying, and dispersing agents. The sterilization may be carried out in several ways, e.g., using a bacteriological filter, by incorporating sterilizing agents in the composition, by irradiation, or by heating. They may be prepared in the form of sterile compositions, which can be dissolved at the time of use in sterile water, or any other sterile injectable medium.

Pharmaceutically acceptable carriers that are of use in the present application include but are not limited to diluents such as starch, pregelatinized starch, lactose, powdered cellulose, microcrystalline cellulose, dicalcium phosphate, tricalcium phosphate, mannitol, sorbitol, sugar and the like; binders such as acacia, guar gum, tragacanth, gelatin, polyvinyl pyrrolidone, hydroxypropyl cellulose, hydroxypropyl methyl cellulose, pregelatinized starch and the like; disintegrants such as starch, sodium starch glycolate, pregelatinized starch, crospovidone, croscarmellose sodium, colloidal silicon dioxide and the like; lubricants such as stearic acid, magnesium stearate, zinc stearate and the like; glidants such as colloidal silicon dioxide and the like; solubility or wetting enhancers such as anionic or cationic or neutral surfactants, complex forming agents such as various grades of cyclodextrins, resins; release rate controlling agents such as hydroxypropyl cellulose, hydroxymethyl cellulose, hydroxypropyl methyl cellulose, ethyl cellulose, methyl cellulose, various grades of methyl methacrylates, waxes and the like. Other pharmaceutically acceptable excipients that are of use include but not limited to film formers, plasticizers, colorants, flavoring agents, sweeteners, viscosity enhancers, preservatives, antioxidants and the like.

The processes of present application are simple, cost effective, eco-friendly, reproducible, scalable, robust to produce the desired polymorphic forms, which are free flowing and directly compressible into stable formulations.

Having thus described the application with reference to particular embodiments and illustrative examples, those in the art may appreciate modifications to the application as described and illustrated that do not depart from the spirit and scope of the application as disclosed in the specification.

The examples are set forth to aid in understanding the application but are not intended to, and should not be construed to limit its scope in any way.

The examples do not include detailed descriptions of conventional methods. Such methods are well known to those of ordinary skill in the art and are described in numerous publications.

### EXAMPLES

### Example 1

To a solution of carvedilol (25.0 g) in ethyl acetate (250 mL), demineralized water (25 mL) is added. The temperature of the reaction mass is raised to about 55° C. and ortho phosphoric acid (7.2 g, 88%) is added slowly. The stirring is continued while maintaining the same temperature for about 60 minutes. The reaction mass is then cooled to about 25° C. and stirred for about 60 minutes. The separated solid is filtered and washed with ethyl acetate (50 mL). The obtained solid is dried under reduced pressure at about 80° C. to afford 31.1 gm of carvedilol dihydrogen phosphate hemihydrate.
Water by KF: 2.13% w/w
Purity by HPLC: 99.93%

### Example 2

To a mixture of THF (50 mL), carvedilol (10 gm) and water (5 mL) at about 30° C., phosphoric acid (2.9 g, 85%) and water (10 ml) are added and the mixture is stirred for about 30 minutes. The reaction mixture is cooled to about 0° C. and cyclohexane (150 ml) is added. The temperature of the reaction mass is raised to room temperature and the reaction mixture is stirred for about 15 minutes. The solid is filtered and washed with water (100 mL). The compound is dried at about 80° C. under vacuum for about 8 hours to afford 11.2 gm of carvedilol dihydrogen phosphate hemihydrate.
Water by KF: 5.9% w/w
Purity by HPLC: 99.98%

### Example 3

A mixture of dioxane (50 mL) and carvedilol base (10 g) is heated to about 45° C. and water (3 mL) is added. The reaction mass is cooled to about 30° C. and phosphoric acid (2.9 g, 85%) is added and it is stirred further for about 30 minutes. The reaction mixture is then cooled to about 10° C. and cyclohexane (100 mL) is added and stirred at room temperature for about 2 hours. The solid is filtered and washed with cyclohexane (50 mL). The cake is dried at about 80° C. under vacuum for about 8 hours to afford 12.6 g of carvedilol dihydrogen phosphate hemihydrate.
Water by KF: 1.7% w/w
Purity by HPLC: 99.73%

### Example 4

To a mixture of DMF (30 mL), carvedilol base (10 g) and water (5 mL), phosphoric acid (2.9 g, 85%) and water (30 mL) are added at about 25° C. The reaction mixture is stirred for about 45 minutes at the same temperature. To the reaction mass another lot of water (30 mL) is added and stirred for about 45 minutes at the same temperature. Further, another lot of water (30 mL) is added and stirred for about 45 minutes at the same temperature. The solid is filtered and washed with water (20 mL). The compound is dried at about 70° C. under vacuum for about 8 hours to afford 8.6 g of carvedilol dihydrogen phosphate hemihydrate.
Water by KF: 2.29% w/w
Purity by HPLC: 99.94%

### Example 5

To a mixture of dimethylacetamide (30 mL) and carvedilol base (10 g), phosphoric acid (2.9 g, 85%) and water (125 mL) are added at about 45° C. The reaction mixture is cooled to about 30° C. and water (30 mL) is added. The reaction mass is stirred for about 4 hours. Another lot of water (60 mL) is added for complete precipitation of solid and it is stirred for about 40 minutes. The solid is filtered and washed with water (50 mL). The cake is dried at about 80° C. under vacuum for about 7 hours to afford 6.8 g of carvedilol dihydrogen phosphate hemihydrate.
Water by KF: 6.2% w/w
Purity by HPLC: 99.98%

### Example 6

To a mixture of N-methyl pyrrolidone (30 mL) and carvedilol base (10 g), phosphoric acid (2.9 g, 85%) is added at about 25° C. Water (180 mL) is added and the reaction mixture is stirred for about 15 minutes. The reaction mixture is cooled to about 10° C. and stirred for about 45 minutes. The solid is filtered and washed with water (50 mL). The cake is dried at about 80° C. under vacuum for about 3 hours to afford 6.1 g of carvedilol dihydrogen phosphate hemihydrate.
Water by KF: 8.29% w/w
Purity by HPLC: 99.87%

### Example 7

A mixture of methyl tertiary butyl ether (150 mL) and carvedilol base (10 g) is heated to about 50° C. To that water (10 mL) and phosphoric acid (2.9 g, 85%) are added and the reaction mixture is stirred for about 45 minutes. The reaction mixture is cooled to about 30° C. and stirred for about 40 minutes. The separated solid is filtered and washed with water (50 mL) and methyl tertiary butyl ether (10 mL). The cake is dried at about 80° C. under vacuum for about 7 hours to afford 11.4 g of carvedilol dihydrogen phosphate hemihydrate.
Water by KF: 4.8% w/w
Purity by HPLC: 99.99%

### Example 8

To a mixture of dichloromethane (100 mL) and carvedilol base (10 g) at about 35° C., water (10 mL) and phosphoric acid (2.9 g, 85%) are added and the reaction mass is stirred for about 45 minutes. Water (30 mL) is added to the reaction mass and the reaction mass is cooled to about 30° C. and stirred for about 40 minutes. The separated solid is filtered and washed with water (50 mL). The cake is dried at about 80° C. under vacuum for about 8 hours to afford 11.8 g of carvedilol dihydrogen phosphate hemihydrate.
Water by KF: 6.2% w/w
Purity by HPLC: 99.95%

### Example 9

To a mixture of water (125 mL) and carvedilol base (25 g), phosphoric acid (6.8 g, 88%) is added at about 30° C. and stirred for about 45 minutes. The separated solid is filtered and washed with water (50 mL). The cake is dried at about 80° C. under vacuum for about 10 hours to afford 28.5 g of carvedilol dihydrogen phosphate hemihydrate.

### Example 10

To a mixture of acetonitrile (100 mL) and carvedilol base (10 g), phosphoric acid (3.0 g, 88%) and water (3 mL) are added at about 30° C. The reaction mixture is stirred for about 100 minutes. The separated solid is filtered and washed with acetonitrile (20 mL). The cake is dried at about 60° C. under vacuum for about 3 hours to afford 12.6 g of carvedilol dihydrogen phosphate hemihydrate.

What is claimed:

1. A process for preparing carvedilol dihydrogen phosphate hemihydrate comprising the step of adding phosphonating agent to a solution comprising carvedilol and a suitable solvent.

2. A process of claim 1, wherein the suitable solvent comprises water and at least one organic solvent.

3. A process of claim 2, wherein the organic solvent comprises a halogenated hydrocarbon, an ester, an ether, a hydrocarbon, or a nitrile.

4. A process of claim 2, wherein the suitable solvent comprises ethyl acetate.

5. A process of claim 2, wherein the ratio of water to organic solvent is about 0.5:50 to about 1:10.

6. A process of claim 1, wherein the phosphonating agent comprises phosphoric acid, a dialkyl phosphate, or a mixture thereof.

7. A process of claim 6, wherein the phosphonating agent comprises phosphoric acid.
